(19) United States
(12) Patent Application Publication
(10) Pub. No.: US 2014/0282212 A1
(43) Pub. Date: Sep. 18, 2014

(54) SYSTEM, METHOD, AND APPARATUS THAT FACILITATES MODIFYING A TEXTUAL INPUT

(71) Applicant: Gary Shuster, Fresno, CA (US)

(72) Inventor: Gary Shuster, Fresno, CA (US)

(21) Appl. No.: 13/839,900

(22) Filed: Mar. 15, 2013

(51) Int. Cl. G06F 3/0484

(52) U.S. Cl. CPC G06F 3/0484
USPC 715/780; 707/755

(57) ABSTRACT

Aspects are disclosed for editing a textual input. In an aspect, a series of strings and an edit command are received such that the strings are parsed based on the edit command. A candidate modification of the strings is inferred from a correlation between the edit command and a parsing of the strings, and the candidate modification is then implemented. In another aspect, a textual input comprising a series of strings is displayed and an edit command is received. The edit command is associated with a portion of the strings, and the portion is then edited based on the edit command. In yet another aspect, a series of strings and an edit command are received, and a candidate modification of the series of strings is inferred based on a combination of a trigger portion and an edit portion of the edit command. The candidate modification is then disseminated.

### TECHNICAL FIELD

The subject disclosure generally relates to modifying a textual input, and more specifically towards editing and/or supplementing a textual input automatically via specialized commands.

### BACKGROUND

By way of background concerning conventional text editing methodologies, it is noted that automatic edits performed via such methods often inaccurately reflect the intent of the user. For instance, many smartphones are equipped with an autocorrect feature that will automatically replace misspelled words with a correctly spelled substitute. Often times, however, the autocorrect feature will undesirably choose a substitute for the misspelled word that the user did not intend (e.g., replacing “bails” with “balls” instead of “nails”). In many cases, since such substitute words may inadvertently transform an innocuous conversation into an inappropriate conversation, users would have actually preferred their misspelled word rather than the autocorrected substitute. Utilizing a smartphone's autocorrect feature thus undesirably makes users review their textual input in search of words that were inaccurately autocorrected. Performing such review though, and manually correcting words that were inaccurately autocorrected, is an exercise that is cumbersome and undesirable.

Accordingly, it would be desirable to provide a mechanism that facilitates modifying a textual input which overcomes these limitations. To this end, it should be noted that the above-described deficiencies are merely intended to provide an overview of some of the problems of conventional systems, and are not intended to be exhaustive. Other problems with the state of the art and corresponding benefits of various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with editing a textual input. In one such aspect, a computing device is provided, which includes a memory having computer executable components stored thereon, and a processor communicatively coupled to the memory and configured to execute the computer executable components. Within such embodiment, the computer executable components include an input component, a parsing component, an inference component, and a modification component. The input component is configured to receive a series of strings and an edit command, which includes at least one of an audio edit command or a gesture edit command, whereas the parsing component is configured to parse the series of strings based on the edit command. The inference component is configured to infer at least one candidate modification of the series of strings, which is inferred from a correlation between the edit command and a parsing of the series of strings. Furthermore, the modification component is configured to implement the at least one candidate modification.

In another aspect, a computer-readable storage medium is provided, which includes a memory component configured to store computer-readable instructions. The computer-readable instructions including instructions for performing various acts including displaying a textual input and receiving an edit command. Within such embodiment, the textual input comprises a series of strings, whereas the edit command is at least one of an audio input or a gesture input. Instructions are also provided for associating the edit command with a portion of the series of strings, and editing the portion of the series of strings based on the edit command.

In a further aspect, a method is provided, which includes employing a processor to execute computer executable instructions stored on a computer readable storage medium to implement various acts. The acts include receiving a series of strings and an edit command, which comprises a trigger portion and an edit portion. The acts further include inferring at least one candidate modification of the series of strings based on a combination of the trigger portion and the edit portion, and subsequently disseminating the at least one candidate modification.

Other embodiments and various non-limiting examples, scenarios and implementations are described in more detail below.

### BRIEF DESCRIPTION OF THE DRAWINGS

FIG. 1 illustrates an exemplary textual input modification in accordance with an aspect of the subject specification.

FIG. 2 illustrates exemplary commands that facilitate a textual input modification according to an embodiment;

FIG. 3 illustrates an exemplary environment that facilitates modifying a textual input in accordance with an aspect of the subject specification.

FIG. 4 illustrates a block diagram of an edit management unit that facilitates modifying a textual input in accordance with an aspect of the subject specification.

FIG. 5 illustrates an exemplary coupling of electrical components that effectuate modifying a textual input according to an embodiment;

FIG. 6 illustrates a flow diagram of an exemplary methodology that facilitates modifying a textual input according to an embodiment.

FIG. 7 illustrates an exemplary coupling of electrical components that effectuate inferring a textual input modification according to an embodiment;

FIG. 8 illustrates a flow diagram of an exemplary methodology that facilitates inferring a textual input modification according to an embodiment.

FIG. 9 is a block diagram representing exemplary non-limiting networked environments in which various embodiments described herein can be implemented.

FIG. 10 is a block diagram representing an exemplary non-limiting computing system or operating environment in which one or more aspects of various embodiments described herein can be implemented.

### DETAILED DESCRIPTION

As discussed in the background, it is desirable to provide a mechanism that facilitates modifying a textual input which overcomes the limitations of conventional systems. The various embodiments disclosed herein are directed towards editing and/or supplementing a textual input automatically via specialized commands. For instance, aspects are disclosed which enable users to readily modify a textual input on their mobile device via audio/gesture commands. In other aspects, methods and computer-readable media are disclosed which facilitate inferring any of a plurality of candidate modifications including, for example, inferring replacements a user may desire for inadvertently autocorrected words.

As used herein, a gesture command is a command defined by path information representing a path traversed by a portable device (e.g., moving a mobile phone up and down) and/or a path traversed by a user's body part as tracked by a camera on a portable device (e.g., a user waving his/her hand in front of the portable device). With respect to analyzing a path traversed by a device, such analysis can include processing acceleration information measuring acceleration of the device, processing velocity information measuring velocity of the device, analyzing the path information for a given time span or analyzing a set of vectors representing the path traversed by the device from a start time to a stop time. (See e.g., U.S. Pat. No. 7,536,201, which is hereby incorporated by reference). With respect to ascertaining a path traversed by a user's body part, imagery captured by a portable device's camera can be used to track a user's movements, wherein particular movements are processed as gesture commands. (See e.g., U.S. Patent Publication No. 2010/0295783, which is hereby incorporated by reference).

Turning now to FIG. 1, an exemplary textual input modification is provided in accordance with an aspect of the subject specification. For this particular example, it is contemplated that a textual input is being entered onto a computing device. For instance, users communicating via a Short Message Service (SMS) may input text onto their mobile device (e.g., via keypad, touch screen, dictation, etc.), wherein the textual input is displayed to the user as it is entered. Here, as illustrated, a textual input includes a series of strings represented by displayed input 100, which includes misspelled input 102. In this example, it is contemplated that an autocorrect feature may automatically replace misspelled input 102 with autocorrected input 112, as shown in displayed input 110 (i.e., “IGNOY” is automatically changed to “IGNITION”). However, as mentioned previously, an autocorrect feature will often choose a substitute for a misspelled word that the user did not intend. For instance, a user who incorrectly typed “IGNOY” may have intended to type “IGNORE”, rather than “IGNITION”. To facilitate such modification, rather than manually replacing “IGNITION” with “IGNORE” via keystrokes, aspects disclosed herein include performing this modification automatically via non-keystroke edit commands. Here, upon receiving such edit command(s), autocorrected input 112 is automatically replaced with modified input 122, as shown in displayed input 120 (i.e., “IGNITION” is automatically changed to “IGNORE”).

Referring next to FIG. 2, exemplary commands that facilitate a textual input modification according to an embodiment are provided. To this end, it is contemplated that an exemplary edit command may include a trigger portion and an edit portion. Within such embodiment, a trigger portion of an edit command may be configured to initiate a search for candidate strings to modify, whereas the edit portion may be configured to execute the desired modification. For instance, as illustrated in FIG. 2, a trigger portion may comprise gesture command 210, whereas the edit portion may comprise audio command 230. For this particular example, a user may have noticed that “IGNOY” was replaced with “IGNITION”, although the user intended to type “IGNORE”. In an aspect, autocorrected input 222 (i.e., “IGNITION”) is automatically replaced with modified input 242 (i.e., “IGNORE”) via gesture command 210 and audio command 230. If a mobile device (e.g., a smart phone) is being used, for example, gesture command 210 may comprise a physical movement of the mobile device, wherein such movement may be tracked by the device's internal circuitry (e.g., via accelerometers within the mobile device). Here, gesture command 210 comprises first stroke 212 (i.e., moving the mobile device downward) and second stroke 214 (i.e., moving the mobile device upward), wherein the combination of first stroke 212 and second stroke 214 may be a pre-determined command that triggers a search for candidate portions of text to modify. In this example, upon receiving gesture command 210, the mobile device identifies autocorrected input 222 as a candidate for modification. In an aspect, autocorrected input 222 may be highlighted within displayed input 220, along with other candidate portions (e.g., other autocorrected words). Next, rather than typing “IGNORE”, a user may replace autocorrected input 222 with modified input 242 by simply providing audio command 230 (i.e., dictating “IGNORE” via the mobile device). Such replacement will then be automatically included in displayed input 240, as shown.

It should be appreciated that the various aspects disclosed herein can be implemented in any of a plurality of ways and by any combination of various components and/or entities. In FIG. 3, an exemplary environment that facilitates modifying a textual input in accordance with an aspect of the subject specification is provided. As illustrated, environment 300 includes user device 320, which is coupled to edit management unit 330 and recipient device 340 via network 310 (e.g., the Internet). Here, it is contemplated that user device 320 (e.g., a personal computer, mobile phone, tablet, etc.) is utilized by a user to communicate with recipient device 340 via network 310. In a particular embodiment, a series of strings input via user device 320 are modified by edit management unit 330 according to the aspects described herein, and subsequently sent to recipient device 340. In another embodiment, rather than operating as a unit separate from user device 320, it should be appreciated that aspects performed by edit management unit 330 may be implemented entirely within user device 320. In yet another embodiment, aspects performed by edit management unit 330 may be implemented via multiple computing devices including, for example, a combination of user device 320 and edit management unit 340.

Referring next to FIG. 4, a block diagram of an exemplary edit management unit that facilitates modifying a textual input according to an embodiment is illustrated. As shown, edit management unit 400 may include processor component 410, memory component 420, input component 430, parsing component 440, inference component 450, modification component 460, and output component 470. Here, it should be noted that processor component 410, memory component 420, input component 430, parsing component 440, inference component 450, modification component 460, and/or output component 470 can reside together in a single location or separated in different locations in various combinations including, for example, a configuration in which any of the aforementioned components reside in a cloud. For instance, with reference to FIG. 3, it is contemplated that these components may reside, alone or in combination, in either of user device 320, edit management unit 330, and/or recipient device 340.

In one aspect, processor component 410 is configured to execute computer-readable instructions related to performing any of a plurality of functions. Processor component 410 can be a single processor or a plurality of processors which analyze and/or generate information utilized by memory component 420, input component 430, parsing component 440, inference component 450, modification component 460, and/or output component 470. Additionally or alternatively, processor component 410 may be configured to control one or more components of edit management unit 400.

In another aspect, memory component 420 is coupled to processor component 410 and configured to store computer-readable instructions executed by processor component 410. Memory component 420 may also be configured to store any of a plurality of other types of data including data generated by any of input component 430, parsing component 440, inference component 450, modification component 460, and/or output component 470. Memory component 420 can be configured in a number of different configurations, including as random access memory, battery-backed memory, Solid State memory, hard disk, magnetic tape, etc. Various features can also be implemented upon memory component 420, such as compression and automatic back up (e.g., use of a Redundant Array of Independent Drives configuration). In one aspect, the memory may be located on a network, such as a “cloud storage” solution.

In yet another aspect, edit management unit 400 includes input component 430, as shown. Within such embodiment, input component 430 is configured to receive a series of strings and an edit command. As mentioned previously, it is contemplated that such edit command may be a non-keystroke command such as an audio edit command or a gesture edit command. As also mentioned previously, it is further contemplated that en edit command may include a series of commands directed at various aspects of a particularly desired modification. For instance, an edit command may for include a trigger portion, which alerts edit management unit 400 that an edit is desired, and an edit portion, which facilitates selecting the particular modification desired.

As illustrated, edit management unit 400 may also include parsing component 440 and inference component 440. Within such embodiment, parsing component 440 is configured to parse the series of strings based on the edit command, whereas inference component 450 is configured to infer candidate modifications for the series of strings. In a particular aspect, candidate modifications are inferred from a correlation between the edit command and a parsing of the series of strings. For instance, inference component 450 may be configured to identify a portion of the series of strings to modify according to a temporal proximity of the edit command to a processing of candidate portions of the series of strings. Indeed, since a user may generally notice a desired edit relatively soon after a corresponding text is displayed (e.g., a misspelling, undesired autocorrect replacement, inaccurate dictation, etc.), inference component 450 may be configured to infer that a user's desired edit corresponds to a recently displayed text.

To facilitate a more efficient processing of inferences, it is noted that parsing component 440 may be configured to limit the data from which inference component 450 makes candidate modification inferences. In one aspect, for example, parsing component 440 may be configured to limit the parsing of the series of strings to a set of autocorrected strings. In another aspect, parsing component 440 may be configured to parse the series of strings according to a dictation of at least a portion of the edit command. For example, if the edit command includes a dictation of the word “IGNORE”, parsing component 440 may be configured to parse the displayed text for words that are similar phonetically and/or in spelling. Within such embodiment, inference component 450 may then be configured to infer candidate modifications based on the dictation (e.g., infer that the auto correction “IGNITION” should have been “IGNORE”).

It is further noted that, rather than replacing displayed text, it may be desirable to augment the displayed text with auxiliary information. To facilitate implementing such feature, inference component 450 may be configured to infer a context associated with the series of strings input by a user, wherein a candidate modification may include augmenting the series of strings with auxiliary information associated with the inferred context. Within such embodiment, edit management unit 400 may be configured to ascertain/retrieve/generate media associated with an input based on an analysis of the series of strings. In an exemplary scenario, inference component 450 may be configured to infer a context for a textual input, wherein the input is a narrative in which a ‘stormy night’ scene is inferred from a textual analysis of the input. Edit management unit 400 may then be further configured to ascertain/retrieve/generate media associated with a ‘stormy night’ scene such as an image file (e.g., a photo/drawing of an evening lightning storm), audio file (e.g., audio of lightning), and/or video file (video of an evening lightning storm).

As illustrated, edit management unit 400 may also include modification component 460, and output component 470. Within such embodiment, output component 470 is configured to display candidate modifications, whereas modification component 460 is configured to implement candidate modifications. In a particular aspect, modification component 460 may be configured to implement a selected modification corresponding to a selection command, wherein the selection command is at least one of an audio selection or a gesture selection. For instance, output component 470 may be configured to facilitate scrolling through a plurality of candidate modifications via a scroll command, wherein the scroll command is at least one of an audio scroll command (e.g., “up” or “down”) or a gesture scroll command (e.g., up tilt or down tilt).

Turning to FIG. 5, illustrated is a system 500 that facilitates modifying a textual input according to an embodiment. System 500 and/or instructions for implementing system 500 can reside within a computing device, for example. As depicted, system 500 includes functional blocks that can represent functions implemented by a processor using instructions and/or data from a computer readable storage medium. System 500 includes a logical grouping 502 of electrical components that can act in conjunction. As illustrated, logical grouping 502 can include an electrical component for displaying a textual input comprising a series of strings 510, as well as an electrical component for receiving an edit command that includes at least one of an audio input or a gesture input 512. Logical grouping 502 can also include an electrical component for associating the edit command with a portion of the series of strings 514. Further, logical grouping 502 can include an electrical component for editing the portion of the series of strings based on the edit command 516. Additionally, system 500 can include a memory 520 that retains instructions for executing functions associated with electrical components 510, 512, 514, and 516. While shown as being external to memory 520, it is to be understood that electrical components 510, 512, 514, and 516 can exist within memory 520.

Referring next to FIG. 6, a flow chart illustrating an exemplary method that facilitates modifying a textual input is provided. As illustrated, process 600 includes a series of acts that may be performed within a computer system (e.g., edit management unit 400) according to an aspect of the subject specification. For instance, process 600 may be implemented by employing a processor to execute computer executable instructions stored on a computer readable storage medium to implement the series of acts. In another embodiment, a computer-readable storage medium comprising code for causing at least one computer to implement the acts of process 600 is contemplated.

In an aspect, process 600 begins with a series of strings being displayed at act 610, wherein the displayed input may be provided via any of a plurality of mechanisms (e.g., via keypad, touch screen, dictation, etc.). As the series of strings are received, process 600 proceeds to act 620 where a user input is monitored for an edit command. As stated previously, it is contemplated that such edit command may include non-keystroke commands such as an audio input and/or a gesture input.

Next, at act 630, process 600 determines whether a trigger portion of an edit command has been detected. If no trigger is detected, process 600 loops back to act 620 where the monitoring for an edit command continues. Otherwise, if a trigger is indeed detected, process 600 proceeds to act 640 where the edit command is associated with a particular portion of strings to potentially edit within the displayed series of strings. In an aspect, a triggering of the associating performed at act 640 thus depends on the detection of a trigger command, wherein the associating commences after a detection of such trigger command. It is contemplated that trigger commands can be any of a plurality of types including, for example, an audio trigger (e.g., triggered upon detecting a voice saying the word “no”) or a gesture trigger (e.g., triggered upon detecting that the mobile device being used is shaken).

It should also be noted that the associating performed at act 640 may comprise any of various acts. For instance, the associating may comprise identifying the portion of the series of strings according to a temporal proximity of the edit command to a processing of the portion of the series of strings. In another aspect, however, the associating comprises selecting the portion of the series of strings from a set of autocorrected strings.

In various embodiments, the associating is facilitated by words dictated by the user. For example, the associating may comprise identifying a candidate word in the series of strings that is similar in spelling to a dictated word included in the edit command. Within such embodiment, the candidate word may have a different pronunciation than the dictated word, but may have a similar spelling (e.g., “IGNITION” and “IGNORE”). In another embodiment, the associating comprises identifying the portion of the series of strings via a guide word included in the edit command. Here, the guide word matches a correctly displayed word in the series of strings and is proximate to the portion of the series of strings (i.e., the dictated guide word is near the strings the user wishes to edit).

After associating the detected edit command with the candidate portion of strings to edit, process 600 proceeds to act 650 where candidate modifications are displayed to the user. Process 600 then receives a modification selection from the user at act 660, and concludes with the portion of strings being edited according to the selected modification at act 670. In an aspect, the editing performed at act 670 comprises replacing the portion of the series of strings with a dictation of at least a portion of the edit command. Within such embodiment, a set of candidate editable strings may be ascertained via a comparison of strings included in the series of strings with the dictation, wherein the associating performed at act 640 may further comprise selecting the portion of the series of strings from the set of candidate editable strings.

Referring next to FIG. 7, illustrated is an exemplary system 700 that facilitates inferring a textual input modification according to an embodiment. System 700 and/or instructions for implementing system 700 can physically reside within a computing device, for instance, wherein system 700 includes functional blocks that can represent functions implemented by a processor using instructions and/or data from a computer readable storage medium. System 700 includes a logical grouping 702 of electrical components that can act in conjunction similar to logical grouping 502 in system 500. As illustrated, logical grouping 702 can include an electrical component for receiving a series of strings and an edit command 710. Furthermore, logical grouping 702 can include an electrical component for inferring at least one candidate modification of the series of strings based on a combination of a trigger portion and edit portion of the edit command 712. Logical grouping 702 can also include an electrical component for disseminating the at least one candidate modification 714. Additionally, system 700 can include a memory 720 that retains instructions for executing functions associated with electrical components 710, 712, and 714. While shown as being external to memory 720, it is to be understood that electrical components 710, 712, and 714 can exist within memory 720.

Referring next to FIG. 8, a flow chart illustrating an exemplary method that facilitates inferring a textual input modification is provided. As illustrated, process 800 includes a series of acts that may be performed within a computer system (e.g., edit management unit 400) according to an aspect of the subject specification. For instance, process 800 may be implemented by employing a processor to execute computer executable instructions stored on a computer readable storage medium to implement the series of acts. In another embodiment, a computer-readable storage medium comprising code for causing at least one computer to implement the acts of process 800 is contemplated.

In an aspect, process 800 begins with an input being received at act 810, wherein the received input includes a series of strings and an edit command. As illustrated, processing the series of strings and edit command can be performed in parallel, although such processing can be performed serially as well. For this particular embodiment, the processing of the series of strings begins at act 820, whereas the processing of the edit command begins at act 830.

When processing the series of strings, it is contemplated that a portion of these strings may include autocorrected strings. Accordingly, in an aspect, autocorrected strings are identified at act 822. To facilitate such identification, it should be noted that metadata describing the series of strings may be received/processed, wherein such data may identify which strings were autocorrected, and may further include a copy of originally misspelled words that were autocorrected. In a further aspect, since some autocorrected words have a higher likelihood of matching a user's intent than others, it is contemplated that such likelihood can be used to more accurately infer desired modifications. For this particular example, accuracy metrics for autocorrected words included in the series of strings are ascertained at act 824. Specifically, each of a set of autocorrected strings can be respectively correlated with a corresponding likelihood of accuracy metric associated with a particular autocorrect implementation. The inferring of candidate modifications can then include identifying a portion of the series of strings to modify based on these correlations.

With respect to processing edit commands at act 830, it is again contemplated that such edit commands may include a trigger portion and an edit portion. Accordingly, process 800 may include identifying a trigger portion of an edit command at act 832, and identifying an edit portion of the edit command at act 834. As stated previously, it is contemplated that either of the trigger portion or the edit portion can be non-keystroke commands such as an audio command or a gesture command.

After processing the series of strings and the edit command, process 800 proceeds to act 840 where candidate modifications to the series of strings are inferred based on a combination of the trigger portion and edit portion of the edit command. In an aspect, because it may be desirable to augment the series of strings with auxiliary information rather than replace any of the strings, a determination of whether to include such auxiliary information can be performed at act 850. Namely, it is contemplated that the inferring of candidate modifications may comprise identifying auxiliary information associated with the series of strings, wherein candidate modifications include an augmentation of the auxiliary information to the series of strings. To this end, it should be noted that auxiliary information may include any of various types of information including, for example, an image, a link, or supplemental text. If it is determined that auxiliary information should not be augmented, process 800 concludes at act 860 with the dissemination of candidate modifications without auxiliary information. Otherwise, if it is determined that auxiliary information should be included with the candidate modification, such information is identified at act 852 and subsequently augmented to the candidate modification at act 854 before being disseminated at act 860.

In a further aspect, it should be appreciated that candidate modifications can be inferred/prioritized according any of a plurality of accessible data. For instance, environmental data sensed/received by a portable device can be used to infer a context for such modifications. Location data (e.g., GPS data) sensed/received by a portable device, for example, may indicate that a user is located at a restaurant. Candidate modifications can then be inferred/prioritized based, in part, on characteristics of this particular restaurant. For instance, candidate autocorrect spellings can be weighted according to words inferred to be more commonly associated with the restaurant (e.g., correct spelling of the restaurant's name, city where the restaurant is located, items on the menu, etc.). Candidate auxiliary information may also be inferred based on location (e.g., a uniform resource locator of the restaurant's website, contact information, social media links, etc.).

Audio analysis of environmental data can also be used to infer/prioritize candidate modifications. For instance, if an audio command is sensed to have been voiced in a low relative volume, candidate autocorrect spellings can be weighted towards words deemed to be socially embarrassing (e.g., “tampon” rather than “tempo”). Similarly, if analysis of an audio command indicates that a voice has a relatively high stress level, candidate autocorrect spellings can be weighted towards words deemed more consistent with such stress (e.g., “deadline” rather than “define”).

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that the embodiments disclosed herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

FIG. 9 provides a non-limiting schematic diagram of an exemplary networked or distributed computing environment. The distributed computing environment comprises computing objects or devices 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects or devices 910, 912, etc. and computing objects or devices 920, 922, 924, 926, 928, etc. may comprise different devices, such as PDAs (personal digital assistants), audio/video devices, mobile phones, MP3 players, laptops, etc.

Each computing object or device 910, 912, etc. and computing objects or devices 920, 922, 924, 926, 928, etc. can communicate with one or more other computing objects or devices 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object or device 910, 912, etc. or 920, 922, 924, 926, 928, etc. can also contain an application, such as applications 930, 932, 934, 936, 938, that might make use of an API (application programming interface), or other object, software, firmware and/or hardware, suitable for communication with or implementation of aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects or devices 910, 912, etc. can be thought of as servers where computing objects or devices 910, 912, etc. provide data services, such as receiving data from computing objects or devices 920, 922, 924, 926, 928, etc., storing of data, processing of data, transmitting data to computing objects or devices 920, 922, 924, 926, 928, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 940 is the Internet, for example, the computing objects or devices 910, 912, etc. can be Web servers with which the computing objects or devices 920, 922, 924, 926, 928, etc. communicate via any of a number of known protocols, such as HTTP. As mentioned, computing objects or devices 910, 912, etc. may also serve as computing objects or devices 920, 922, 924, 926, 928, etc., or vice versa, as may be characteristic of a distributed computing environment.

### Exemplary Computing Device

As mentioned, several of the aforementioned embodiments apply to any device wherein it may be desirable to utilize a computing device to implement the aspects disclosed herein. It is understood, therefore, that handheld, portable and other computing devices and computing objects of all kinds are contemplated for use in connection with the various embodiments described herein. Accordingly, the below general purpose remote computer described below in FIG. 10 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 10 thus illustrates an example of a suitable computing system environment 1000 in which one or more of the embodiments may be implemented, although as made clear above, the computing system environment 1000 is only one example of a suitable computing environment and is not intended to suggest any limitation as to the scope of use or functionality of any of the embodiments. The computing environment 1000 is not to be interpreted as having any dependency or requirement relating to any one or combination of components illustrated in the exemplary operating environment 1000.

With reference to FIG. 10, an exemplary remote device for implementing one or more embodiments herein can include a general purpose computing device in the form of a handheld computer 1010. Components of handheld computer 1010 may include, but are not limited to, a processing unit 1020, a system memory 1030, and a system bus 1021 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user may enter commands and information into the computer 1010 through input devices 1040 A monitor or other type of display device is also connected to the system bus 1021 via an interface, such as output interface 1050. In addition to a monitor, computers may also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and networks, the underlying concepts may be applied to any network system and any computing device or system. Moreover, one of ordinary skill will appreciate that there are multiple ways of implementing one or more of the embodiments described herein (e.g., an appropriate API, tool kit, driver code, operating system, control, standalone or downloadable software object, etc.). Embodiments may be contemplated from the standpoint of an API (or other software object), as well as from a software or hardware object that facilitates implementing one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

What is claimed is:

1. A computer-readable storage medium comprising:
computer-readable instructions, the computer-readable instructions including instructions that when executed by at least one processor cause the at least one processor to perform the following acts:
displaying a textual input, the textual input comprising a series of strings;
receiving an edit command, wherein the edit command is at least one of an audio input or a gesture input;
associating the edit command with a portion of the series of strings; and
editing the portion of the series of strings based on the edit command.

2. The computer-readable storage medium of claim 1, the associating comprising identifying the portion of the series of strings according to a temporal proximity of the edit command to a processing of the portion of the series of strings.

3. The computer-readable storage medium of claim 1, the associating comprising selecting the portion of the series of strings from a set of autocorrected strings.

4. The computer-readable storage medium of claim 1, the associating comprising identifying a candidate word in the series of strings that is similar in spelling to a dictated word included in the edit command, the candidate word having a different pronunciation than the dictated word.

5. The computer-readable storage medium of claim 1, the associating comprising identifying the portion of the series of strings via a guide word included in the edit command, the guide word matching a correctly displayed word in the series of strings and proximate to the portion of the series of strings.

6. The computer-readable storage medium of claim 1, the editing comprising replacing the portion of the series of strings with a dictation of at least a portion of the edit command.

7. The computer-readable storage medium of claim 6, the computer-readable instructions further comprising instructions to facilitate ascertaining a set of candidate editable strings via a comparison of strings included in the series of strings with the dictation, the associating further comprising selecting the portion of the series of strings from the set of candidate editable strings.

8. The computer-readable storage medium of claim 1, the computer-readable instructions further comprising instructions to facilitate a triggering of the associating via a trigger command, wherein the associating commences after a detection of the trigger command.

9. The computer-readable storage medium of claim 8, wherein the trigger command is at least one of an audio trigger or a gesture trigger.

10. A method comprising:
employing a processor to execute computer executable instructions stored on a computer readable storage medium to implement the following acts:
receiving a series of strings and an edit command, the edit command comprising a trigger portion and an edit portion;
inferring at least one candidate modification of the series of strings based on a combination of the trigger portion and the edit portion; and
disseminating the at least one candidate modification.

11. The method of claim 10, further comprising respectively correlating each of a set of autocorrected strings with a corresponding likelihood of accuracy metric associated with a particular autocorrect implementation, the inferring comprising identifying a portion of the series of strings to modify based on the correlating.

12. The method of claim 10, the inferring comprising identifying auxiliary information associated with the series of strings, the at least one candidate modification including an augmentation of the auxiliary information to the series of strings.

13. The method of claim 12, the auxiliary information including at least one of an image, a link, or supplemental text.

14. A computing device, comprising:
a memory having computer executable components stored thereon; and
a processor communicatively coupled to the memory, the processor configured to execute the computer executable components, the computer executable components comprising:
an input component configured to receive a series of strings and an edit command, wherein the edit command is at least one of an audio edit command or a gesture edit command;
a parsing component configured to parse the series of strings based on the edit command;
an inference component configured to infer at least one candidate modification of the series of strings, the at least one candidate modification inferred from a correlation between the edit command and a parsing of the series of strings; and
a modification component configured to implement the at least one candidate modification.

15. The computing device of claim 14, further comprising an output component configured to display the at least one candidate modification, wherein the modification component is configured to implement a selected modification corresponding to a selection command, and wherein the selection command is at least one of an audio selection or a gesture selection.

16. The computing device of claim 15, the output component configured to facilitate scrolling through a plurality of candidate modifications via a scroll command, wherein the scroll command is at least one of an audio scroll command or a gesture scroll command.

17. The computing device of claim 14, the inference component configured to identify a portion of the series of strings to modify according to a temporal proximity of the edit command to a processing of candidate portions of the series of strings.

18. The computing device of claim 14, the parsing component configured to limit the parsing of the series of strings to a set of autocorrected strings.

19. The computing device of claim 14, the parsing component configured to parse the series of strings according to a dictation of at least a portion of the edit command, the inference component configured to infer the at least one candidate modification based on the dictation.

20. The computing device of claim 14, the inference component configured to further infer a context associated with the series of strings, wherein the at least one candidate modification includes augmenting the series of strings with auxiliary information associated with the context.
